(19) United States
(12) Patent Application Publication
(10) Pub. No.: US 2006/0012062 A1
(43) Pub. Date: Jan. 19, 2006

(54) Method and apparatus for metering and controlling dispense rate

(76) Inventors: Douglas McBain, Wadsworth, OH (US); Elliott Straus, Akron, OH (US); John Thompson, Wooster, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/530,768

(22) PCT Filed: Oct. 3, 2003
(86) PCT No.: PCT/US03/31291

§ 371 Date: Apr. 7, 2005

Related U.S. Application Data
(60) Provisional application No. 60/422,783, filed on Oct. 31, 2002.

(51) Int. Cl. B29C 45/16; B29C 45/76

(52) U.S. Cl. 264/40.1; 264/255; 264/40.7; 425/130; 425/129.1; 425/145

(57) ABSTRACT

A method is provided for metering and controlling the dispense rate of an in-mold coating composition into a mold cavity (16) and onto a thermoplastic molded article contained therein. A heated thermoplastic material is injected into the mold cavity (16). The thermoplastic material is allowed to form a thermoplastic article in the mold cavity (16). An in-mold coating composition is injected into the mold cavity (16) and onto the thermoplastic article. The amount of said in-mold coating composition injected into the mold cavity (16) and onto the article is controlled. The rate that the in-mold coating composition is injected into the mold cavity (16) and onto the in-mold coating article is controlled.

### BACKGROUND INFORMATION

The present invention relates to a method and apparatus for metering and controlling the dispense rate of an in-mold coating (IMC) composition into a mold cavity and onto a molded article or substrate formed from a resin within the mold cavity. The present invention finds particular application as a feedback and control device on a metering cylinder of a dispense and control apparatus that is connected to an injection molding machine.

Molded thermoplastic and the thermoset articles, such as those made from polyolefins, polycarbonates, polyesters, polyethylenes, polypropylenes, polystyrenes and polyurethanes, are utilized in numerous applications including those for the automotive, marine, recreation, construction, office products, and outdoor equipment industries. Oftentimes, it is desirable to apply a surface coating to a molded thermoplastic or thermoset article. For example, the molded articles may be used as one part in multi-part assemblies. To “match” the finish of the other parts in such assemblies, the molded articles may require application of a surface coating that has the same finish properties as the other parts. Coatings may also be used to improve surface properties of the molded article such as uniformity of appearance, gloss, scratch resistance, chemical resistance, weatherability, and the like. In addition, surface coatings may be used to facilitate adhesion between the molded article and a separate finish coat to be later applied to the molded article.

Numerous techniques have been developed to apply surface coatings to molded plastic articles. Many of these techniques involve the application of a surface coating to plastic articles after they are removed from their molds. These techniques are often multi-step processes involving surface preparation followed by spray-coating the prepared surface with paint or other finishes. In contrast, IMC provides a means of applying a surface coating to molded plastics prior to ejection from the mold. IMC can eliminate the separate manufacturing process of applying a coating to the article upon ejection from the mold thereby reducing the overall cost of manufacturing the article.

Molds used with thermoplastics usually are of a “clam shell”-like design having mated halves that meet at a parting line. One of the mated halves typically remains stationary whereas the other half of the mold is typically movable between a closed position and an open, retracted position. To form a molded article, the movable half is moved to its closed position and held closed under a clamping force thereby forming a contained molding cavity. Molten thermoplastic material is injected into the molding cavity. The molded article is formed by thoroughly filling the cavity with the thermoplastic material and allowing the material to sufficiently cool and solidify. During the entire molding process, the movable mold half is maintained in its closed position. After molding, the mold halves can be opened and a finished, molded article can be ejected therefrom.

Owing to differences in mold design and molding conditions, processes wherein the mold is cracked or parted prior to injection of an IMC composition are generally not used for the IMC of injection molded thermoplastics. When molding thermoplastics, it is generally necessary to maintain pressure on the movable mold half to keep the cavity closed and prevent material from escaping along the parting line. Further, it is often necessary to “pack” or maintain pressure on the thermoplastic article during molding which also necessitates keeping the cavity closed. Packing the mold helps to provide a more uniform crystalline or molecular structure in the molded article. Without packing, the physical properties of the molded thermoplastic article tend to be impaired.

Because injection molding of thermoplastics does not permit the mold to be parted or cracked prior to injection of the IMC into the mold cavity, the IMC composition must be injected under sufficient pressure to compress the thermoplastic article in all areas that are to be coated. By compressing the thermoplastic article, the IMC composition is able to interpose between molding surfaces of the mold cavity and outer surfaces of the molded thermoplastic article. The process of in-mold coating an injection molded thermoplastic article with a liquid IMC is described in commonly owned, copending U.S. Pat. No. 6,617,033 entitled “Method For In-Mold Coating a Polyolefin Article” issued on Sep. 9, 2003; and U.S. patent application Ser. Nos. 09/974,644 entitled “Optimization of In-Mold Coating Injection Molded Thermoplastic Substrate” filed on Oct. 9, 2001; and 10/045,481 entitled “Selectively Controlling In-Mold Coating Flow” filed on Oct. 22, 2001.

The method and apparatus used to physically inject the liquid IMC composition into the molding cavity is described in commonly owned, copending U.S. patent application Ser. No. 60/422,784 entitled “Dispense and Control Apparatus And Method For In-Mold Coating An Injection Molded Thermoplastic Article”. The dispense and control apparatus discloses a delivery system for injecting an IMC composition into the cavity of a pair of mold halves on an injection molding machine and a means for controlling the delivery system. However, when injecting IMC composition into the molding, it may be desirable to be able to precisely and variably control the amount and the rate at which the IMC composition is injected over the entire period that IMC composition is injected into the molding cavity.

Variably controlling the dispense rate of in-mold coating composition during each injection of the IMC composition into the mold cavity would enable the dispense rate to be adjusted to better correspond to changing conditions within the mold cavity. For example, at the beginning of the IMC injection, a higher dispense rate may be needed to deform the molded substrate and to interpose the IMC composition between the molded substrate and the surface or surfaces of the mold halves. After deformation, a relatively lower dispense rate may be needed to avoid leakage of the injected IMC composition through the mold parting line. At or near the end of the injection of IMC, a relatively higher rate of dispense may be needed to fully coat the molded part because the part is becoming cooler and the coating must be forced into the remote areas or regions of the molded part. Additionally, it is desirable to more precisely control the dispense rate of IMC composition to better correlate the dispense rate with the conditions occurring in the mold cavity.

### SUMMARY OF THE INVENTION

The present method for metering and controlling the dispense rate of an IMC composition into a mold cavity and onto a thermoplastic molded article contained therein that overcomes the foregoing difficulties and others and provides the aforementioned and other advantageous features. The method involves injecting a heated thermoplastic material into the mold cavity, allowing the thermoplastic material to form a thermoplastic article in the mold cavity, and injecting an IMC composition into the mold cavity (16) and onto the thermoplastic article. Both the amount of and rate that the coating composition is injected into said mold cavity are controlled. The method for metering and controlling can include the use of a linear transducer and programmed logic controller for metering the amount of and rate that the IMC composition is dispensed. Additionally, the method can involve dispensing a first amount of an IMC composition at a first rate, dispensing a second amount of IMC composition at a second rate that is less than the first rate, and, optionally, dispensing a third amount of IMC composition at a third rate that is greater than the second rate.

In another aspect of the present invention, an apparatus is provided for controlling the amount and rate of an IMC composition injected into a molding cavity and onto a thermoplastic molded article formed therein. More particularly, in accordance with this aspect of the invention, at least two mold members define a mold cavity. A first composition injector is fluidly connected to the mold cavity for injecting a first composition into the mold cavity. A second composition injector is fluidly connected to the mold cavity for injecting the IMC composition into the mold cavity. The second injector includes a metering cylinder fluidly connected to the molding cavity and holding the IMC composition. A hydraulically driven piston extends into the metering cylinder for evacuating an amount of the IMC composition held therein upon movement in a first direction of the piston. A means for controlling the amount of the IMC composition evacuated by the piston from the metering cylinder is provided. A means for controlling the rate that the piston evacuates the IMC composition from the metering cylinder is also provided.

Advantageously, the dispense rate of an IMC composition into a mold cavity can be variably controlled over time. Further, this control can be very precise.

Additionally, the maximum IMC composition injection pressure can be regulated by controlling the injection rate. Pressure feedback can be obtained by measuring the dispense amount and rate.

### BRIEF DESCRIPTION OF THE DRAWINGS

FIG. 1 is a side view of one embodiment of a molding apparatus suitable for use in or with a preferred embodiment of the present invention.

FIG. 2 is a partial cross-section through a vertical elevation of a mold cavity.

FIG. 3 is a perspective view of an in-mold coating dispense and control apparatus adapted to be connected to the molding apparatus of FIG. 1 according to a preferred embodiment of the present invention.

FIG. 4 is a cross-sectional view of a metering cylinder assembly of the dispense and control apparatus of FIG. 3 wherein the metering cylinder assembly includes a linear transducer.

### DETAILED DESCRIPTION OF ILLUSTRATIVE EMBODIMENTS

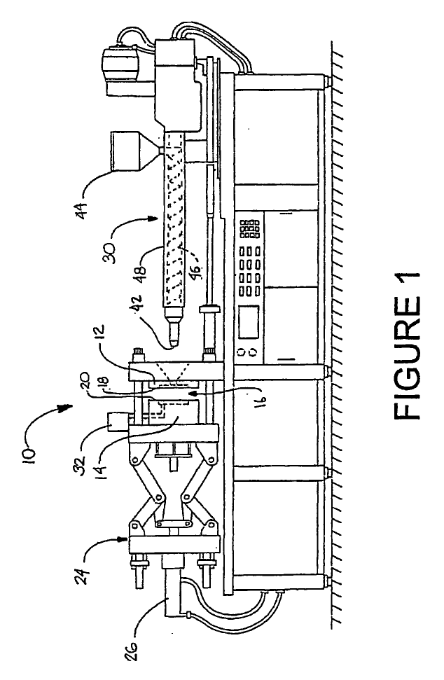

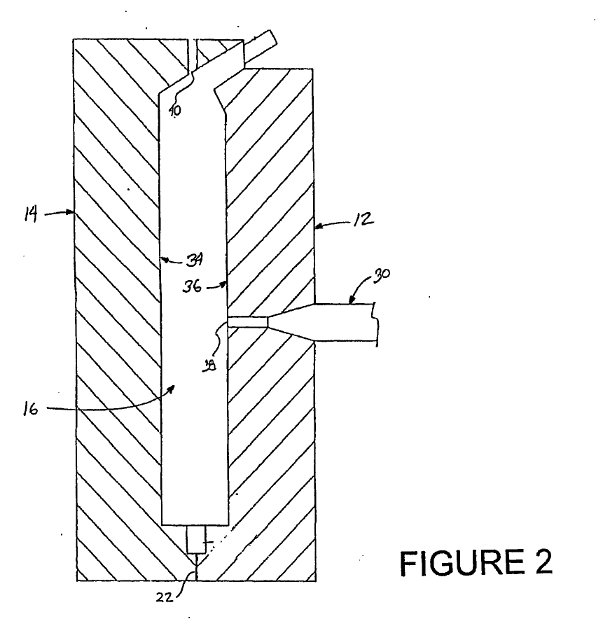

Referring now to the drawings wherein the showings are for purposes of illustrating a preferred embodiment of the invention only and not for purposes of limiting the same and like reference numerals are used to indicate like or corresponding parts throughout the several figures, FIG. 1 shows a molding apparatus or injection molding machine 10 according to a preferred embodiment of the present invention. Molding apparatus 10 includes a first mold half 12 and a second mold half 14. First mold half 12 preferably remains in a stationary or fixed position. In FIG. 1, movable mold half 14 is shown in an open position. Movable mold half 14 is movable to a closed position wherein the first and second mold halves mate with one another to form a contained mold cavity 16 therebetween (See FIG. 2). More specifically, mold halves 12, 14 mate along surfaces 18 and 20 (FIG. 1) when movable mold half 14 is in the closed position, forming a parting line 22 (FIG. 2) therebetween and around mold cavity 16.

Moveable mold half 14 reciprocates generally along a horizontal axis relative to first or fixed mold half 12 by action of a clamping mechanism 24 with a clamp actuator 26 such as through a hydraulic, pneumatic or mechanical actuator as known in the art. The clamping pressure exerted by clamping mechanism 24 should have an operating pressure in excess of the pressures generated or exerted by either one of a first composition injector 30 and a second composition injector 32. In the preferred embodiment, the pressure exerted by clamping mechanism 24 ranges generally from about 13.8 to about 103.3 MPa (i.e., 2,000 to about 15,000 pounds per square inch (psi)), preferably from about 27.6 to about 82.7 MPa (4000 to 12,000 psi), and more preferably from about 41.3 to about 68.9 MPa (6000 to 10,000 psi) on the mold surface.

With additional reference to FIG. 2, mold halves 12, 14 are shown in a closed position abutting or mating with one another along parting line 22 to form mold cavity 16. It should be readily understood by those skilled in the art that the design of mold cavity 16 can vary greatly in size and shape according to the desired end product or article to be molded. Mold cavity 16 generally has a first surface 34 on second mold half 14, upon which a show surface of an article will be formed, and a corresponding or opposite second surface 36 on first mold half 12. First mold half 12 defines a first orifice 38 connecting to mold cavity 16 that allows first composition injector 30 to inject its composition into mold cavity 16. Similarly, second mold half 14 defines a second orifice 40, also connecting to mold cavity 16 that allows second composition injector 32 to inject its composition into mold cavity 16.

First composition injector 30 is that of a typical injection molding apparatus which is well known to those of ordinary skill in the art. More specifically, first composition injector 30 is generally capable of injecting a thermoplastic composition, generally a resin or polymer, into mold cavity 16. Owing to space constraints, first injector 30 used to inject the thermoplastic composition is positioned to inject material from fixed half 12 of the mold. It is to be understood that first composition injector 30 could be reversed and placed in movable mold half 14. Second composition injector 32 is generally capable of injecting an IMC composition into mold cavity 16 to coat the molded article formed therein. In the illustrated embodiment, second injector 32 is shown positioned in movable mold half 14. However, it is to be understood that second injector 32 could be alternatively positioned in stationary mold half 12.

First composition injector 30 is shown in a “backed off” position, but it is readily understood that the same can be moved in a horizontal direction so that a nozzle or resin outlet 42 of first composition injector 30 mates with mold half 12. In the mated position, first composition injector 30 is capable of injecting its contents into mold cavity 16. For purposes of illustration only, first composition injector 30 is shown as a reciprocating-screw machine wherein a first composition can be placed in a hopper 44 and a rotating screw 46 can then move the composition through a heated extruder barrel 48, where the first composition or material is heated above its melting point. As the heated material collects near the end of barrel 48, rotating screw 46 acts as an injection ram and forces the material through nozzle 42 and into mold cavity 16. Nozzle 42 generally has a valve (not shown) at the open end thereof and rotating screw 46 generally has a non-return valve (not shown) to prevent the backflow of material into rotating screw 46.

First composition injector 30 is not meant to be limited to the embodiment shown in FIG. 1 but can be any apparatus capable of injecting a thermoplastic composition into mold cavity 16. For example, the injection molding machine can have a mold half movable in a vertical direction such as in a “stack-mold” with center injection. Other suitable injection molding machines include many of those available from Cincinnati-Milacron, Inc. (Cincinnati, Ohio); Battenfeld Injection Molding Technology (Meinlerzhagen, Germany); Engel Machinery Inc. (York, Pa.); Husky Injection Molding Systems Ltd. (Bolton, Canada); BOY Machines Inc. (Exton, Pa.) and others.

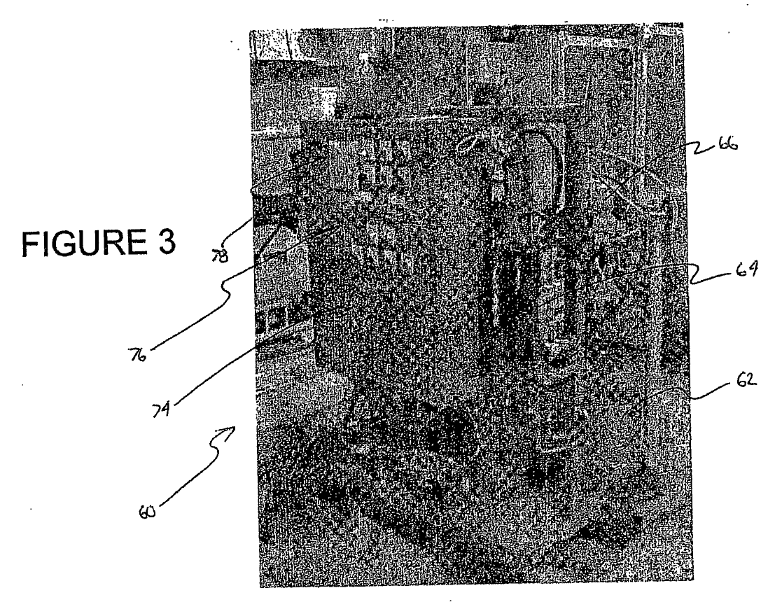

With reference to FIG. 3, an IMC dispense and control apparatus 60 is capable of being connected to molding apparatus 10 for providing IMC capabilities and controls therefor to molding apparatus 10. Control apparatus 60 is more fully described in the above-referenced commonly owned, copending '784 application. Generally, control apparatus 60 includes a receiving cylinder 62 for holding an IMC container filled with an IMC composition. A suitable IMC composition is disclosed in commonly owned, U.S. Pat. No. 5,777,053 entitled “In-Mold Coating Compositions Suitable As Is For An End Use Application”. Control apparatus 60 further includes a metering cylinder or tube 64 and an air-driven transfer pump 66. Metering cylinder 64 is selectively and fluidly connectable to the coating container in receiving cylinder 62. More specifically, a fluid line (not shown) connects the coating container to metering cylinder 64. A valve (not shown) is provided on the fluid line for controlling communication therethrough. Transfer pump 66 is adapted to selectively pump the IMC composition of the coating container to metering cylinder 64 when the valve is in an open position.

Using conventional fluid communication lines (not shown), metering cylinder 64 is fluidly connectable to second injector 32 of molding apparatus 10. A hydraulic means such as a hydraulically driven piston is provided for selectively evacuating IMC composition held in metering cylinder 64 therefrom as will be described in more detail below. The evacuated IMC composition is directed by and through the fluid communication lines to second injector 32. Control apparatus 60 includes appropriate connections (not shown) for connecting control apparatus 60 to a conventional electric power source and a conventional compressed air source. Specifically, control apparatus 60 includes an electric box 74 that is capable of being connected to a conventional 460 volt AC or DC power outlet. Electric box 74 includes a plurality of controls 76 and a touch pad controller 78 thereon for controlling the dispensing of the IMC coating composition from control apparatus 60 to molding cavity 16 of molding apparatus 10 as will be described in more detail below. The electric power source provides power for the electronics, electronic controls and hydraulic pump of control apparatus 60. The compressed air source provides power for transfer pump 66.

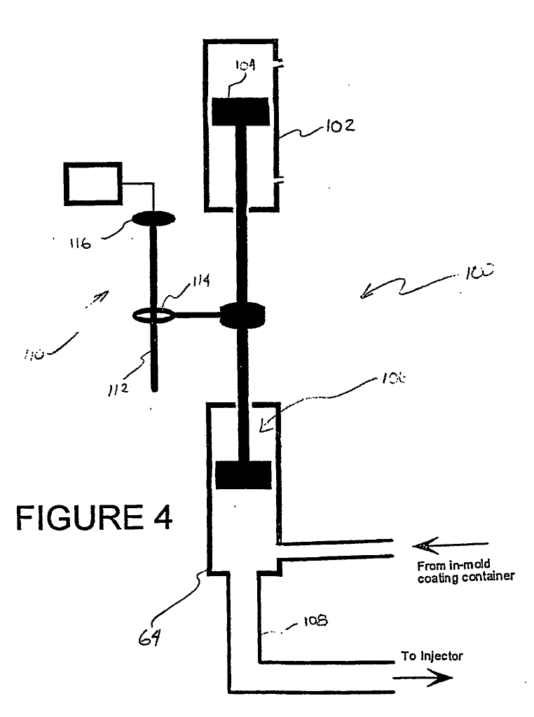

With reference to FIG. 4, a metering cylinder assembly 100 is shown including metering cylinder 64 and the hydraulic means for evacuating or forcing the contents, such an amount of an IMC composition, held or contained within metering cylinder 64 therefrom. Specifically, the hydraulic means includes a hydraulic cylinder 102 and a hydraulically actuated piston 104 selectively driven by hydraulic cylinder 102. Piston 104 is connected to a rod or shaft assembly 106 that extends into metering cylinder 64. Hydraulic cylinder 102 can be electronically-controlled as is well-known in the art and powered by the dispense and control apparatus 60. Alternatively, a pneumatic cylinder or mechanical gear driven cylinder could be used in place of the hydraulic means.

Shaft assembly 106 is movable between a retracted position and an extended position. In the retracted position, shaft assembly 106 is retracted toward one end of metering cylinder 64 and allows an amount or volume of an in-mold coating composition to be provided to metering cylinder 64 and held therein. In the fully extended position, shaft assembly 106 is extended into metering cylinder 64 toward the other end thereof. Moving from the retracted position to the extended position, shaft assembly 106 expunges or evacuates an amount of an IMC composition contained within metering cylinder 64 therefrom. When evacuated, the expunged amount of IMC composition is directed through a conduit or evacuation fluid line 108 which directs the removed amount of the IMC composition toward second injector 32. It should be noted that the fluid communication lines of control apparatus 60 are generally filled with a static load of IMC composition.

In accordance with the present invention, a linear transducer 110 is provided for measuring linear travel, including the position, movement and/or speed, of shaft assembly 106 relative to a fixed point on metering cylinder 64. Linear transducer 110 can be a conventional linear transducer such as a TEMPOSONIC™ R series sensor (MTS Systems Corp.; Cary, N.C.). Specifically, linear transducer 110 includes a sensor tube or rod 112 and a circular magnet or toroidal member 114 annularly disposed about rod 112. The toroidal member 114 is connected to shaft assembly 106 such that toroidal member 114 moves with shaft assembly 106. Rod 112 generally extends in the same direction as the movement of piston assembly 106 and is held in a fixed position relative thereto. Alternatively, rod 112 could be connected to shaft assembly 106 and toroidal member 114 could be held in a fixed position. In either arrangement, an electronic pulse or current pulse is created in a head 116 of linear transducer 110 and sent speeding down rod 112. The current pulse interacts with a magnetic field created by toroidal member 114 thereby producing a strain pulse that travels back up rod 112 to head 116. The position of toroidal member 114 is determined by the amount of time it takes between launching the electronic pulse and the strain pulse to return. Of course, the position of toroidal member 114 corresponds to the position of shaft assembly 106 within metering cylinder 64.

Based on the determined position of toroidal member 114 on rod 112, linear transducer 110 produces a voltage reading that is sent to a programmable logic controller or PLC (not shown) that forms part of dispense and control apparatus 60. Using the PLC, shaft assembly 106 can be controlled by position and/or linear travel between two positions. For example, shaft assembly 106 via piston 104 can be moved to a specified location or position such as its retracted position, its extended position, or any specified position therebetween. Shaft assembly 106 can also be moved via piston 104 from one specified position to another over a predetermined time interval. In other words, the rate of travel or speed of shaft assembly 106 can be controlled. The speed at which the piston 104 and shaft assembly 106 move corresponds to the pressure at which the amount of IMC composition is evacuated from metering cylinder 64.

Using linear transducers and PLCs to control piston movement in hydraulic cylinders is generally well known by those skilled in the art. Additionally, there are several alternative known mechanisms that can be used to precisely and variably control hydraulic cylinder 102 of the present invention. Linear transducer 110 shown and described herein is for illustrative purposes only and is not intended to limit the present invention. All other known means of precisely and variably controlling hydraulic cylinders and/or providing position and travel related feedback are to be considered within the scope of the present invention.

To make an IMC thermoplastic article, with reference to FIG. 1, a thermoplastic first composition is placed in hopper 44 of molding apparatus 10. First injector 30 is moved into nesting or mating relation with fixed mold half 12. Through conventional means, i.e., using heated extruder barrel 48 and rotating screw 46, first injector 30 heats the first composition above its melting point and directs the heated first composition toward the nozzle 42 of first injector 30. Mold halves 12, 14 are closed thereby creating contained molding cavity 16.

Next, a nozzle valve (not shown) of nozzle 42 is moved to an open position for a predetermined amount of time to allow a corresponding quantity of first composition to enter mold cavity 16. Rotating screw 46 provides a force or pressure that urges the first composition into mold cavity 16 until the nozzle pin is returned to its closed position. The first composition is filled and packed into mold cavity 16 as is well known in the art. Once mold cavity 16 is filled and packed, the molded first composition is allowed to cool thereby forming a molded thermoplastic article.

While the molding process is occurring, the valve controlling fluid communication between the IMC coating container and metering cylinder 64 is moved to its open position to permit fluid communication between the coating container and metering cylinder 64. Shaft assembly 106 is in its retracted position at this time, i.e. during filling of metering cylinder 64. Transfer pump 66 then pumps the IMC composition from the coating container to metering cylinder 64. When metering cylinder 64 is filled to a desired amount, the valve closes to prevent more IMC composition from entering metering cylinder 64. Next, control apparatus 60 opens a valve or pin (not shown) on second injector 32 to allow fluid communication between second injector 32 and mold cavity 16. The pin is normally bias or urged toward a closed position but is selectively movable toward the open position by control apparatus 60. Specifically, an electrically powered hydraulic pump (not shown) of control apparatus 60 is used to move the pin.

After the first composition has been injected into mold cavity 16 and the surface of the molded article to be coated has cooled below the melt point or otherwise reached a temperature or modulus sufficient to accept or support an IMC composition but before the surface has cooled too much such that curing of the IMC composition would be inhibited, the hydraulic means is actuated. Specifically, the PLC, using linear transducer 106, directs hydraulic piston 104 to move from its initial, retracted position to a first specified position whereby shaft assembly 106 extends into the metering cylinder 64 thereby evacuating an amount of IMC composition from metering cylinder 64. In addition to moving piston 104 and shaft assembly 106 to a specified position, the PLC also controls the rate at which hydraulic position 104 moves to the first specified position. Generally, the rate will correspond to a pressure at which the IMC composition is evacuated from metering cylinder 64 and injected into mold cavity 16 by second injector 32. The rate at which piston 104 travels to its first specified position and the corresponding pressure of that rate may be such to deform the substrate and interpose the IMC composition between the thermoplastic molded article and the walls of one or both of mold halves 12, 14.

Next, piston 104 and shaft assembly 106 can be moved from the first specified position to a second specified position at a different, typically decreased, rate of travel. The new rate may correspond to a pressure that is low enough to avoid leakage of the IMC composition through parting line 22. Finally, piston 104 and shaft assembly 106 can be moved from the second specified position to a third specified position or the extended position of piston 104. The rate of speed piston 104 and shaft assembly 106 travel in route to the third specified position is again adjustable and may correspond to a rate and pressure sufficient to fully coat the molded thermoplastic article with the IMC composition. The rate of speed of this third movement may need to be higher than the second movement because the molded thermoplastic article may be cooler and the IMC composition may need to be forced into remote locations on the molded part.

Although the IMC process has been described with reference to three movements used to evacuate the IMC composition from metering cylinder 64 and fully coat the part, it should be understood that any number of movements are possible and a varying or same rate of speed may be used on each movement. All combinations of movements and speeds are to be considered within the scope of the present invention.

As each movement of piston 104 and shaft assembly 106 evacuates the IMC contained in metering cylinder 64 and delivers the IMC to second injector 32, the IMC composition is injected through the nozzle (not shown) and into mold cavity 16. The IMC composition spreads out from the mold surface and coats a predetermined portion or area of the molded article. Immediately or very shortly after the IMC composition is fully injected into mold cavity 16, control apparatus 60 allows the valve of second injector 32 to return to its closed position thereby preventing further injection of the IMC composition into mold cavity 16. It is important to note that the mold is not opened or unclamped before the IMC composition is applied. That is, mold halves 12, 14 maintain a parting line 22 and generally remain substantially fixed relative to each other while both the first and second compositions are injected into mold cavity 16.

After the predetermined amount of IMC composition is injected into mold cavity 16 and it covers or coats the predetermined area of the article or substrate, the coated substrate can be removed from the mold. However, before the mold halves 12, 14 are parted, the IMC composition is cured by components present within the coating composition. The cure is optionally heat activated, from sources including the substrate or mold halves which are at or above the curing temperature of the IMC composition. Cure temperature will vary depending on the in-mold coating utilized. As mentioned above, it is important to inject the IMC composition before the molded article has cooled to the point below where proper curing of the composition can be achieved. The IMC composition requires a minimum temperature to activate the catalyst present therein which causes a cross-linking reaction to occur, thereby curing and bonding the composition to the substrate.

Controls 76 and keypad 78 of control apparatus 60 enable an operator to adjust and/or set certain operating parameters of control apparatus 60. For example, controls 76 can be manipulated to increase or decrease the amount of IMC composition to be filled in metering cylinder 64 by allowing the valve that controls communication between metering cylinder 64 and receiving container 62 to remain open for a longer duration. Further, controls 76 which communicate with the PLC can be used to set the number of movements made by hydraulic piston 104, the specified location or locations that piston 104 moves to, i.e., its length of travel, and the rate at which piston 104 moves during each movement. As mentioned above, these rates can be adjusted to provide the IMC composition into mold cavity 16 at optimal pressures that correspond to the molding process and the coating of the molded thermoplastic article.

Although the present invention has been illustrated and described as using a linear transducer in conjunction with a PLC, it is contemplated that a variable control valve positioned downstream of metering cylinder 64 could be used to accomplish several of the functions performed by linear transducer 110. The control valve could be electronically controlled by the PLC as is known in the art to variably and precisely control the pressure at which the in-mold coating composition is delivered to molding cavity 16. Alternatively, the variable control valve could be used in addition to linear transducer 110 to provide two means for variably and precisely controlling the dispense rate of the in-mold coating composition into mold cavity 16. Use of a control valve to variably and precisely meter and control the dispense rate of the IMC composition with or without linear transducer 110 is to be considered within the scope of the present invention. It is further contemplated that all disclosed means of variably and precisely controlling the dispense rate of the IMC composition disclosed in the present invention could be used on one or more of the multiple component metering cylinders disclosed in commonly owned, co-pending U.S. patent application Ser. No. 60/422,740 entitled “High Pressure Delivery and Mixing System for Multiple In-Mold Coating Components and Method of Delivering and Mixing Multiple In-Mold Coating Components” filed on Oct. 31, 2002. In the '740 application the positioning of a variable control valve, if included, would preferably be between the mixer and the second injector.

1. A method for metering and controlling the dispense rate of an in-mold coating composition into a mold cavity and onto a thermoplastic molded article contained therein, the method comprising the steps of:
(a) injecting a heated thermoplastic material into said mold cavity;
(b) allowing said thermoplastic material to form a thermoplastic article in said mold cavity; and
(c) injecting an in-mold coating composition into said mold cavity and onto said thermoplastic article, wherein both the amount of and rate that said coating composition is injected into said mold cavity are controlled.

2. The method of claim 1 further comprising the step of maintaining mold members that define said mold cavity at a substantially fixed distance relative to one another throughout steps (a) through (c).

3. The method of claim 2 further comprising the step of maintaining said mold members such that said mold cavity has a substantially fixed volume in step (a) and the same said substantially fixed volume in step (c).

4. The method of claim 1 wherein said step of injecting said in-mold coating composition includes dispensing a first amount of said in-mold coating composition at a first rate sufficient to interpose said in-mold coating composition between said article and walls defining said mold cavity and dispensing a second amount of said in-mold coating composition at a second rate that is less than said first rate to avoid leakage of said in-mold coating composition through a parting line.

5. The method of claim 4 wherein the step of injecting said in-mold coating composition further includes dispensing a third amount of said in-mold coating composition at a third rate that is more than said second rate and sufficient to fully coat desired portions of said article.

6. The method of claim 1 wherein the amount of and the rate that said in-mold coating composition is injected into said mold cavity is metered through the use of a linear transducer in combination with a programmed logic controller.

7. The method of claim 1 wherein the control of the amount of in-mold coating composition injected includes the steps of:
using a hydraulic cylinder with a piston extending into a metering cylinder of said in-mold coating composition to evacuate said in-mold coating composition from said metering cylinder and direct said in-mold coating composition to said mold cavity;
measuring linear travel by said piston; and
operating said hydraulic cylinder based on said linear travel measured.

8. The method of claim 1 wherein the control of the amount of and the rate that said in-mold coating composition is injected includes the steps of:
measuring the position of a piston used to force said in-mold coating composition into said mold cavity; and
controlling the speed and distance said piston (104) travels based on measurements taken of said piston.

9. The method of claim 1 wherein the step of injecting said in-mold coating includes:
dispensing said in-mold coating composition from a metering cylinder through a fluid line fluidly connected to said mold cavity; and
controlling the amount and rate of said in-mold coating dispensed from said metering cylinder.

10. An apparatus for controlling the amount and rate of an in-mold coating composition injected into a molding cavity and onto a thermoplastic molded article formed therein, comprising:
(a) at least two mold members defining said mold cavity;
(b) a first composition injector fluidly connected to said mold cavity for injecting a first composition into said mold cavity;
(c) a second composition injector fluidly connected to said mold cavity for injecting said in-mold coating composition into said mold cavity, said second injector including:
(i) a metering cylinder fluidly connected to said molding cavity and holding said in-mold coating composition,
(ii) a hydraulically driven piston extending into said metering cylinder for evacuating an amount of said in-mold coating composition held therein upon movement in a first direction of said piston,
(iii) a means for controlling said amount of said in-mold coating composition evacuated by said piston from said metering cylinder, and
(iv) a means for controlling the rate that said piston evacuates said in-mold coating composition from said metering cylinder.

11. The apparatus of claim 10 wherein said means for controlling said amount of said in-mold coating composition evacuated by said piston is a linear transducer operatively connected to said piston and to a programmed logic controller.

12. The apparatus of claim 10 wherein said means for controlling the rate that said piston evacuates said in-mold coating composition is a linear transducer operatively connected to said piston and to a programmed logic controller.

13. A method for metering and controlling an in-mold coating dispense rate, comprising:
injecting a heated first composition into a mold cavity defined between first and second mold members;
allowing said heated first composition to cool to form a molded article;
injecting an in-mold coating composition into said mold cavity and onto said molded article;
controlling a rate that said in-mold coating composition is injected into said mold cavity and onto said molded article; and
maintaining said first and second mold members at a substantially fixed distance relative to one another throughout said steps of injecting said first composition and injecting said in-mold coating composition.

14. The method of claim 13 further including the step of maintaining the first and second mold members such that the mold cavity has a substantially fixed volume throughout said steps of injecting said first composition and injecting said second composition.

15. The method of claim 13 wherein said in-mold coating composition is dispensed at a first rate sufficient to interpose between said molded article and walls of said mold cavity.

16. The method of claim 15 wherein said in-mold coating composition is subsequently dispensed at a second rate that is less than said first rate to avoid leakage of said in-mold coating composition.

17. The method of claim 16 wherein said in-mold coating composition is subsequently dispensed at a third rate that is greater than said second rate to fully coat desired portions of said molded article.

18. The method of claim 13 further including the step of controlling an amount of said in-mold coating composition injected into said mold cavity and onto said molded article.

19. The method of claim 13 wherein said step of injecting said in-mold coating composition includes:
moving a piston to force said in-mold coating composition from a metering cylinder into said mold cavity and onto said molded article.

20. The method of claim 19 wherein said step of controlling said rate occurs by employing a linear transducer connected to said piston to measure travel thereof and employing a controller connected to said piston and to said linear transducer to control movement and travel of said piston thereby controlling said rate said piston forces said in-molding coating composition from said metering cylinder into said mold cavity and onto said molded article.
